(19) United States
(12) Patent Application Publication
(10) Pub. No.: US 2005/0066743 A1
(43) Pub. Date: Mar. 31, 2005

(54) Device for detecting rail movement

(76) Inventor: Siegfried Pieper, Worms (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/494,003

(22) PCT Filed: Oct. 17, 2002
(86) PCT No.: PCT/EP02/11596

(30) Foreign Application Priority Data
Oct. 28, 2001 (DE) 10152380.7

(51) Int. Cl. G01N 3/20

(52) U.S. Cl. 73/849

(57) ABSTRACT

The invention concerns a device for retaining a motion sensor consisting of a transmitter (2) and a receiver (3). The transmitter (2) and the receiver (3) are form-closed on the structural element (1) respectively by means of a housing (20, 30) and a retaining element (21) corresponding to the housing (20, 30) and connected thereto by a screw connection (22). Therefor, the housing (20, 30) and the retaining element (21) form a clamping connection with the structural element (1), the housing (20, 30) comprising a clamping element (23) in operative connection with the structural element (1).

The invention relates to a device for a transmitter and for a receiver for detecting various deformation states of a component that, independently of each other, are arranged on the component at a distance from each other by means of a receptacle.

A deformation sensor is already known from international application WO 01/18487 A1 in which a transmitter and a receiver for measuring deformation states are arranged together on a plate. Here, the plate is attached to a component by means of at least one clamping element, whereby the clamping element has two pointed or round contact parts and at least one bore corresponding to the plate.

The invention is based on the objective of configuring and arranging a holding device for a transmitter-receiver unit in such a way that simple and precise assembly is ensured.

This objective is achieved according to the invention in that the transmitter is arranged on a first holding part by means of a first receptacle and the receiver is arranged on a second holding part by means of a second receptacle, whereby, together with the component, each receptacle and each holding part form one or more connecting elements or one or more clamped and positive-fit joints or a glued joint or a welded joint. In this manner, the transmitter and the receiver are arranged on the component independently of each other, whereby the receptacle serves simultaneously as part of the clamped joint for the transmitter and the receiver. By integrating the receptacle into the clamping device, during the clamping procedure, the receptacle is deformed, thus causing an adjustment of the transmitter or the receiver. The independence of the transmitter and receiver receptacle or holding part ensures that the component absorbs the deformation in a manner that is free of influences. Neither the transmitter nor the receiver absorb a force that is generated by the deformation of the component.

For this purpose, it is also advantageous for the receptacle and the holding part to have a corresponding fit, whereby this fit is configured as a groove-and-tongue joint and/or as a location pin. Thanks to the fit, the assembly effort or the adjustment effort of the receptacle on the holding part is reduced to a minimum.

Moreover, it is advantageous for the receptacle to be configured as a lug and to be connected to the holding part by means of a pin joint and/or a bolted joint, whereby the receptacle and/or the holding part has a clamping element that is configured as a bolt, a screw and/or a cam and that interacts with the component. Through the use of an additional clamping element, the receptacle can be attached to the holding part independently of the clamped joint. By means of the independent clamping element, the receptacle can be moved together with the holding part relative to the component, without the connection between the receptacle and the holding part having to be severed.

It is of special significance for the present invention for the receptacle to have a holding element for the transmitter and/or the receiver, whereby the holding element is configured as a bore and has a fastening element configured as a cap nut for the transmitter and/or the receiver. The configuration as a precision bore ensures an optimal protection for the transmitter or the receiver which, if the bore is sufficiently long, can be inserted into the bore and sunk there.

It is also advantageous for the first receptacle for the transmitter and the second receptacle for the receiver to have at least one corresponding adjustment surface that can be joined using an assembly device, whereby the adjustment surface is configured as a groove, a bore and/or a bevel and the assembly device has adjustment elements such as a tongue or a pin that correspond to the adjustment surface. In this manner, a transmitter receptacle and a receiver receptacle can be aligned relative to each other in a simple manner. The assembly device can be used for any receptacles and does not have to stay on the device.

Moreover, it is advantageous for there to be several receptacles within a measuring area of the component, whereby the receivers are in operative connection via an evaluation unit.

An additional possibility according to another embodiment is for there to be several transmitter-receiver pairs arranged on opposite sides of the component. When the device is used for measuring rail systems, the transmitter and the receiver are positioned on opposite sides of the rail, that is to say, on the right-hand and left-hand sides of the rail relative to the longitudinal axis of the rail, and they extend along a rail section between 3 m and 30 m that is to be measured.

Finally, it is advantageous for a measuring current generated by the receiver to be transformed into a measuring voltage inside the evaluation unit, and the angular change between the transmitter and the receiver upon which the voltage change is based is determined according to the following formula:

$$\frac{{U}_{1} - {U}_{2}}{{U}_{1} + {U}_{2}} = Δ {α}_{1}$$

In this context, it is advantageous for the load forces F_{Q}, F_{Y} upon which the deformation of the component is based to be determined at a right angle to the longitudinal direction of the component according to the following formula:

$$\begin{matrix}{F}_{Q} = \frac{Δ {α}_{1} + Δ {α}_{2}}{2} \\ {F}_{Y} = \frac{Δ {α}_{1} - Δ {α}_{2}}{Δ {α}_{1} + Δ {α}_{2}}\end{matrix}$$

wherein F_{Q} stands for the force in the direction of the vertical and F_{Y} stands for the force running at a right angle thereto, and α₁, α₂ stand for the angular change of at least two different transmitter-receiver pairs that are arranged on one side of and/or opposite to the component relative to the Y-direction.

For this purpose, it is also advantageous for the deformation ΔX of the component to be proportional to the detected angular change Δα and for it to be detected as a function of the component length L, whereby the surface area of a deformation graph “X over L” determined in this manner is normalized through a mean value formation ΔX′ of all of the deformation graphs upon which one load cycle is based, and the ratio of the deformation ΔX to the normalized deformation ΔX′ is calculated. For the normalization, all of the deformation graphs corresponding to a normal load are averaged. The graphs diverging from a normal deformation are not taken into account since these distort the overall result of the mean load graph. Thus, all variables such as temperature, rail bed condition, material condition and basic load of the component are eliminated so as to ensure that the deformation of the component is represented so as to correspond to the basic load.

Finally, it is advantageous for the connecting element to consist of the holding part that can be placed underneath the rail foot and of a receiving part arranged thereupon so as to be height-adjustable and made up of two legs, whereby at least two screws can be screwed into the one leg, whereby the one screw can be placed against the component or the rail foot, and the other screw part creates a fixed connection between the holding part and the component or the rail, whereby the second leg can be pressed against the holding part by means of at least one screw.

Additional advantages and details of the invention are explained in the patent claims and in the description and they are depicted in the figures. The following is shown:

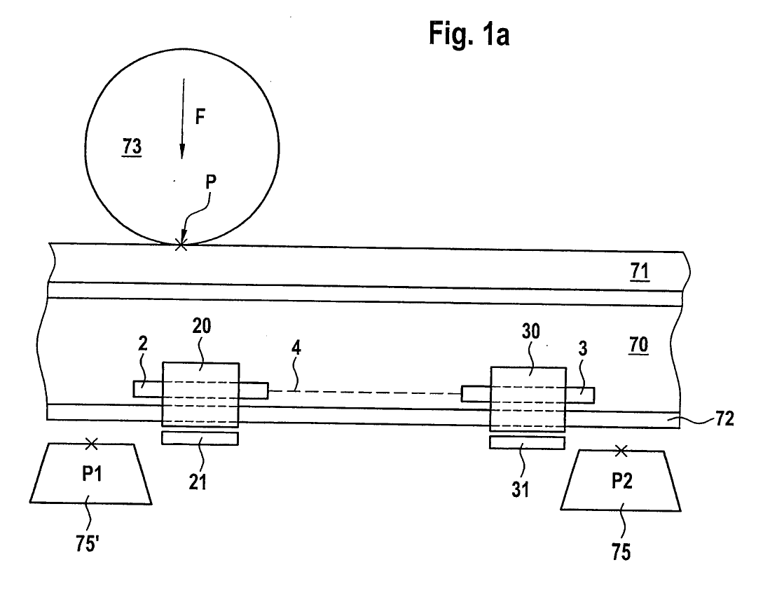

FIG. 1a a schematic representation of a rail with a transmitter and a receiver;

FIG. 1b a schematic representation of the rail with a transmitter-receiver unit;

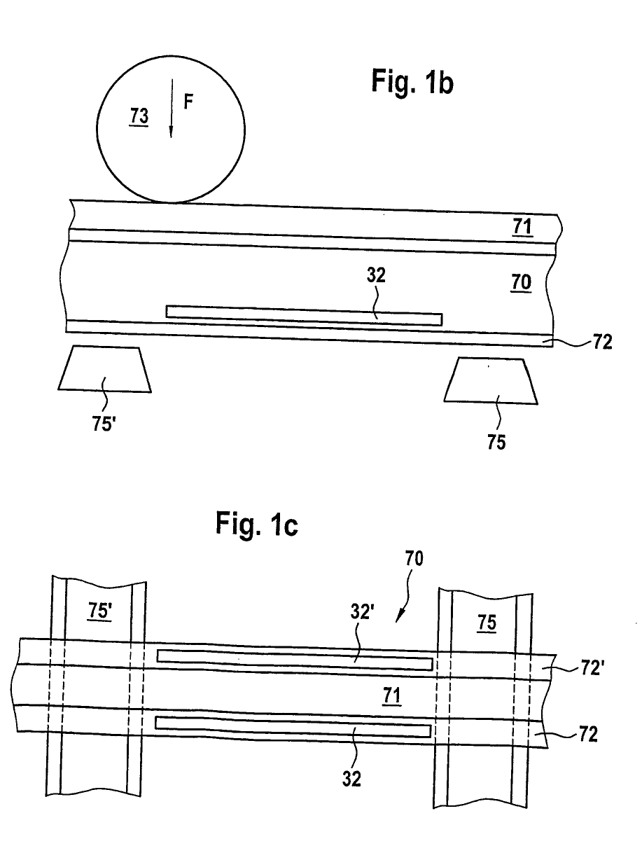

FIG. 2 a schematic representation of a cross section of the rail with a receptacle and a holding part;

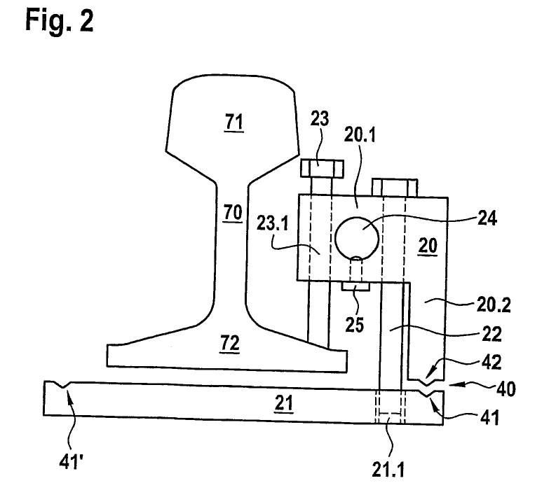

FIG. 3 a schematic representation of the rail with the receptacle and an assembly device;

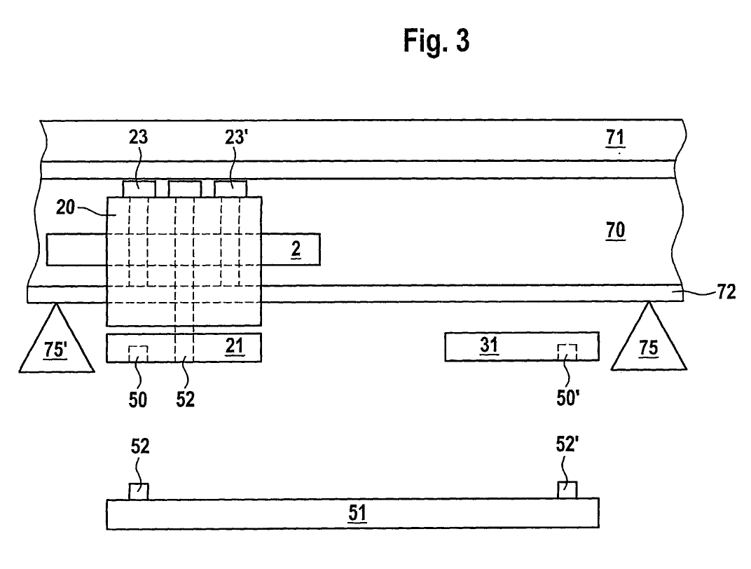

FIG. 4a a schematic representation of the rail with the transmitter, the receiver and a measuring beam;

FIG. 4b a schematic representation of the transmitter and of the receiver with a neutral measuring beam;

FIG. 4c a schematic representation of the transmitter and of the receiver with a deflected measuring beam;

FIG. 4d a schematic representation of the transmitter and of the receiver in a side view with a deflected measuring beam;

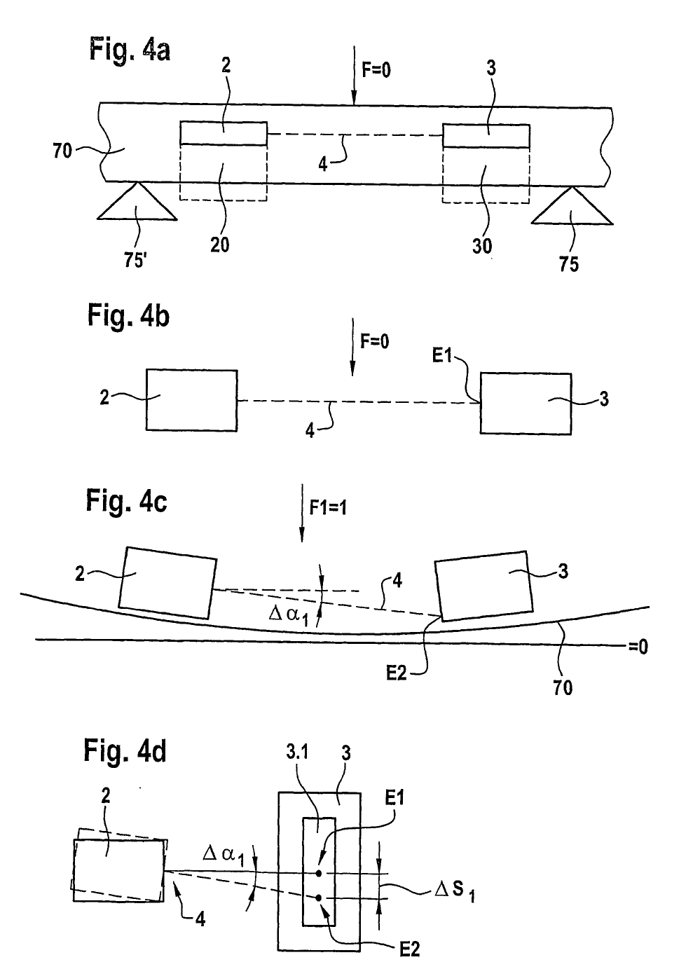

FIG. 5 the receiver with a current tap and part of the evaluation unit;

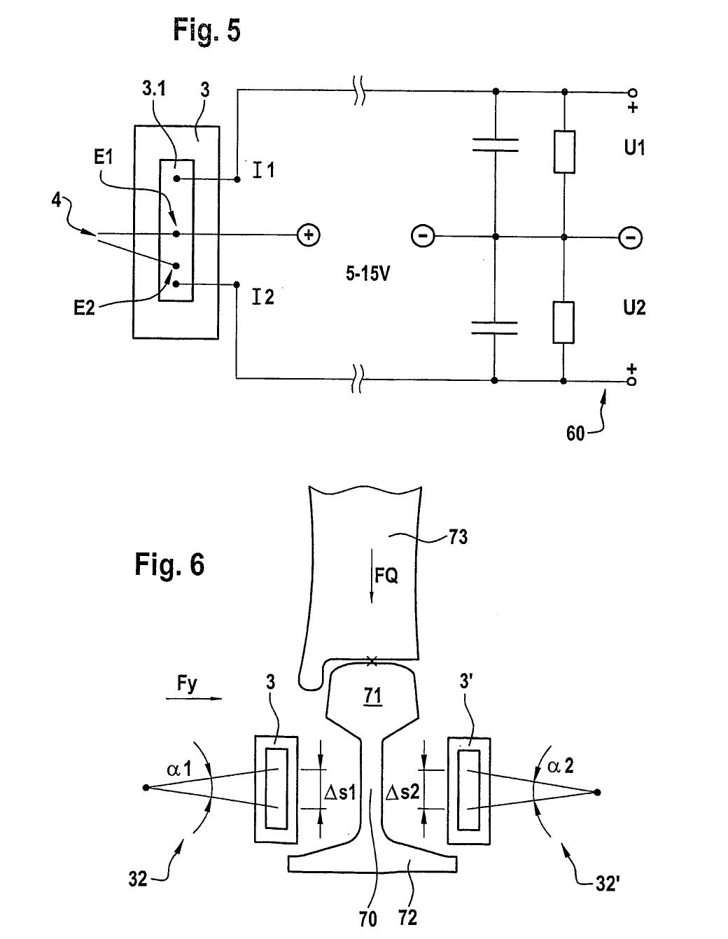

FIG. 6 a schematic representation of the rail in a cross section with receivers arranged opposite and with a deflected measuring beam;

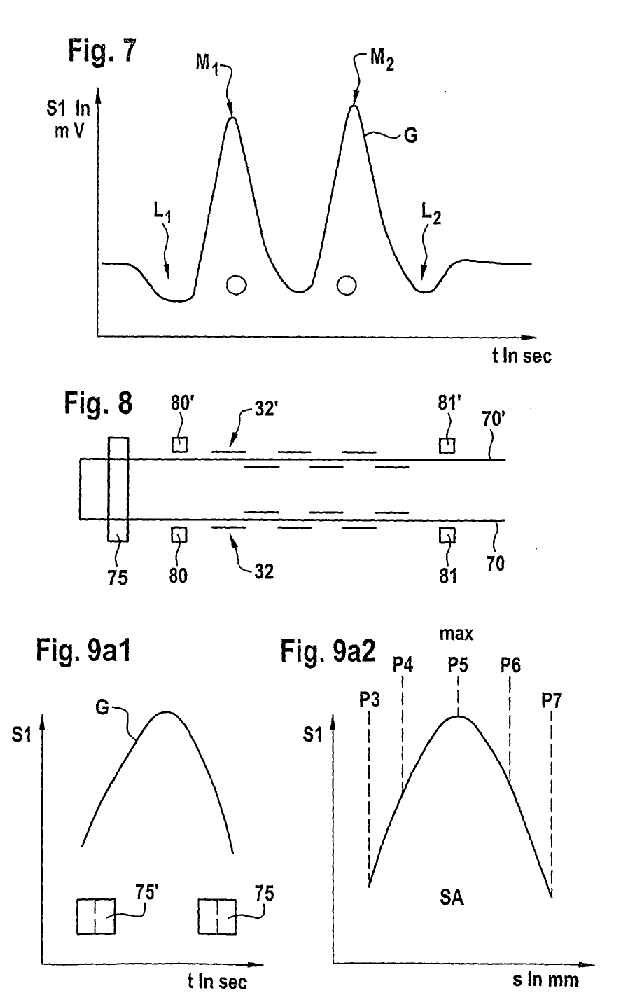

FIG. 7 a measuring graph of two wheels depicting approaching and leaving;

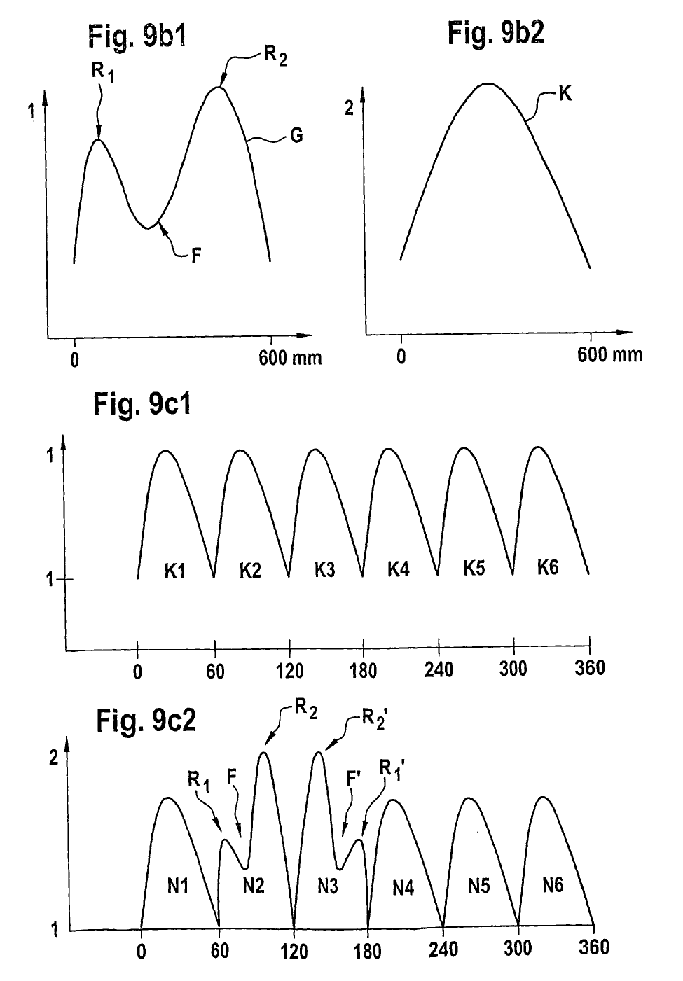

FIG. 8 a schematic representation of a rail bed with several transmitter-receiver units and two detection switch pairs;

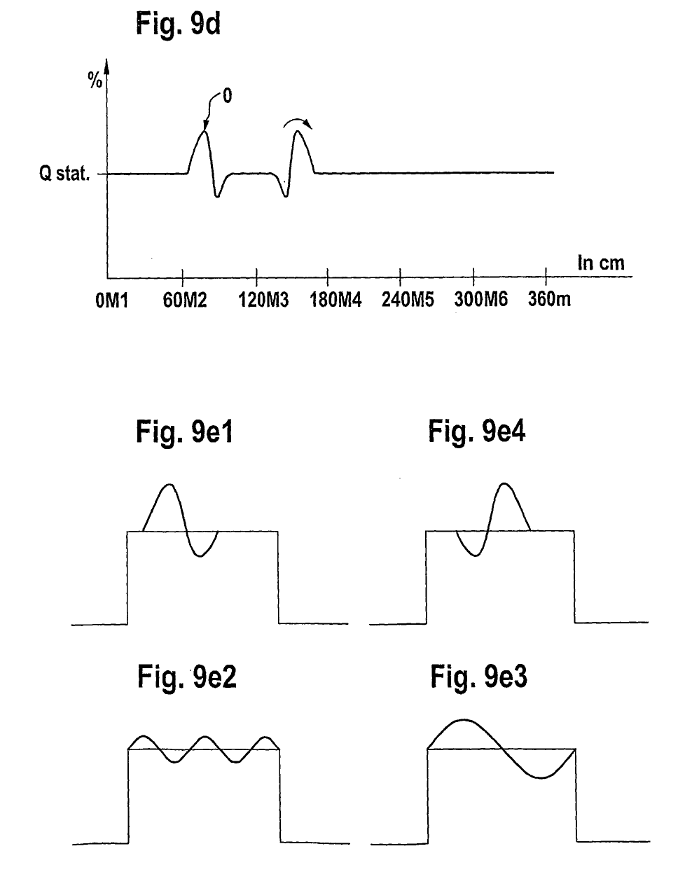

FIG. 9a1 a measuring graph of a bending line between two railroad ties over the time t;

FIG. 9a2 a measuring graph of a bending line between two railroad ties over the path s;

FIG. 9b1 a measuring graph of a bending line between two railroad ties over the path s with a flat section;

FIG. 9b2 a correction graph for a bending line between two railroad ties over the path s;

FIG. 9c1 a correction graph for several sensing points over the path s;

FIG. 9c2 a measuring graph of several sensing points over the path s;

FIG. 9d a representation of the relationship between the measuring graph and the correction graph over the path s;

FIG. 9e1 a representation of a plotting of the wheel through a load plateau;

FIG. 9e2 a representation of a polygon of the wheel through a load diagram;

FIG. 9e3 a representation of an out-of-roundness of the wheel through a load diagram;

FIG. 9e4 a representation of a flat section of the wheel through a load diagram.

FIG. 1a shows a side view of a railroad rail 70 with a rail head 71 and a rail foot 72. A load force F of a wheel 73 of a passenger or freight train (not shown here) acts upon the rail 70. Here, the force F is introduced into the rail at the point P. Through the points P1 and P2 or the railroad ties 75, 75′, the force F is dissipated in the form of a surface compression into the substrate 76, 76′ or into the rail bed, shown in an idealized manner. Due to the load F, a deformation of the rail 70 and of the elastic rail bed occurs which is picked up by means of a transmitter 2 and a receiver 3.

Here, the transmitter 2 or the receiver 3 is provided in a first receptacle 20 or in a second receptacle 30, respectively, that are arranged on the rail foot 72 of the rail 70 by means of a first holding part 21 or by means of a second holding part 31. Here, the first receptacle 20 or the second receptacle 30 will follow the deformation of the rail 70 or the deformation of the rail foot 72 caused by the load F and will thus pick up the deformation cycle. In order to pick up the deformation cycle, no force is transmitted between the transmitter 2 or the first receptacle 20 and the receiver 3 or the second receptacle 30, so that the deformation cycle is determined in a manner that is loss-free or influence-free.

According to FIG. 1b, a uniform transmitter-receiver unit 32 is arranged in the area of the rail foot 72. Here, the transmitter-receiver unit 32 can be configured as a resistance strain gauge and/or as a waveguide that is arranged in the longitudinal direction of the rail.

FIG. 1c shows two transmitter-receiver units 32, 32′ arranged opposite from each other relative to the longitudinal direction of the rail 70. The attachment is once again on the appertaining rail foot 72 or 72′. The appertaining transmitter-receiver unit 32 is provided over the entire length between the railroad tie 75 and the railroad tie 75′.

In FIG. 2, the first receptacle 20 for the transmitter 2 or for the receiver 3 is arranged on the rail foot 72 of the rail 70. For this purpose, the first receptacle 20 has a screwed joint 22 with a first holding part 21. In addition to the screwed joint 22, the first receptacle 20 with the first holding part 21 has a fit 40 consisting of a tongue 42 of the first receptacle 20 and a groove 41 of the first holding part 21. The screwed joint 22 presses the tongue 42 into the groove 41 so that a positive-fit joint is ensured between the first receptacle 20 and the first holding part 21.

The first receptacle 20 is configured so as to be essentially L-shaped and it has a first leg 20.1 and a second leg 20.2. Between the second leg 20.2 and the first holding part 21, the fit 40 is provided with the tongue 42 and the groove 41. The tongue 42 is arranged on the second leg 20.2 of the first receptacle 20 and the groove 41 is arranged on the first holding part 21. Thanks to the fit 40, in addition to the screwed joint 22, a positive-fit joint is ensured between the first receptacle 20 and the first holding part 21.

The connecting element can consist of the holding part that can be placed underneath the rail foot and of a receiving part made up of two legs and arranged thereupon so as to be height-adjustable, whereby at least two screws can be screwed into the one leg, whereby the one screw can be placed against the component or the rail foot, and the other screw part creates a fixed connection between the holding part and the component or the rail, whereby the second leg can be pressed against the holding part by means of at least one screw.

The first leg 20.1 of the first receptacle 20 has a holding element 24 configured as a bore that serves to receive the transmitter 2 or the receiver 3. In order to secure the transmitter 2 or the receiver 3, there is a fastening element (not shown here) configured as a cap nut that is arranged on the front of the transmitter or of the receiver. The screwed joint 22 passes through the first leg 20.1 and engages a thread 21.1 of the first holding part 21.

In addition to the screwed joint 22 and the fit 40, there is a clamping element 23 that is connected to the rail foot 72 by means of a thread 23.1. Consequently, the clamping element 23, which is configured as a screw, braces the first receptacle 20 against the rail foot 72 by means of the first holding part 21. The fit 40 ensures a clear-cut positioning of the second leg 20.2 relative to the first holding part 21. Due to the pretensioning force of the clamping element 23, a bending force is introduced into the second leg 20.2 that leads to a deformation and thus to an adjustment of the holding element 24 for the transmitter 2 and/or the receiver 3.

On the opposite side of the rail 70, the first holding part 21 has a second groove 41′ that serves to secure another receptacle (not shown here).

According to FIG. 3, the first receptacle 20 and the first holding part 21 are provided in the area of the rail foot 72. In addition to the first holding part 21, there is a second holding part 31 that serves to receive the second receptacle 30 for the receiver 3. There is an assembly device 51 for assembling the first receptacle 20 or the second receptacle 30. The assembly device 51 has adjustment elements 52, 52′ that can be joined to an adjustment surface 50 of the first holding part 21 and to an adjustment surface 50′ of the second holding part 31. The adjustment elements 52, 52′ are configured so as to be pin-shaped and they engage the adjustment surfaces 50 and 50′ that are configured as bores.

According to FIG. 3, the adjustment surface 50 and the adjustment surface 50′ are provided on the bottom of the first holding part 21 and of the second holding part 31, respectively. It is also possible to arrange the adjustment surfaces 50, 50′ on another side surface of the receptacle 20 and/or of the holding part 21.

The schematic representation according to FIG. 4a shows a rail 70 with the two railroad ties 75, 75′ as well as a transmitter 2 and a receiver 3. The transmitter 2 and the receiver 3 are arranged on the rail 70 by means of a first receptacle 20 or a second receptacle 30. When the rail is not yet loaded, the measuring beam 4 emitted by the transmitter 2 strikes approximately in the middle of the receiver 3 or else on a receiver surface that is not shown here. According to FIG. 4b, the measuring beam 4 strikes the place E1 of the receiver 3 that represents the zero point. No measuring signal is generated.

In FIG. 4c, a load F1 causes a deformation of the rail 70. As a result, the transmitter 2 and the receiver 3 are rotated in their relative position corresponding to the bending of the rail 70 by an angle ad1 with respect to each other. The measuring beam 4 then strikes the receiver 3 at a place E2 that is at a distance ds1 from the point E1. In this manner, a measuring signal is generated that corresponds to the distance between the point E1 and the point E2 on the receiver 3 or on a receiver surface 3.1.

The distance that is designated as ds1 in FIG. 4d is proportional to the angular change da1 and thus proportional to the force change df1 between a resting position according to FIG. 4a and the load state according to FIG. 4c.

FIG. 5 shows the position change of the measuring beam 4 from E1 to E2 on the receiver 3 or its receiver surface 3.1. This position change generates a measuring current I1 or I2 that is transformed into a measuring voltage U1 or U2 by the evaluation unit 60. The angular change da1 that is proportional to the deformation or to the force application is calculated according to the following formula:

$$\frac{{U}_{1} - {U}_{2}}{{U}_{1} + {U}_{2}} = Δ {α}_{1} = Δ {S}_{1} = Δ {F}_{1}$$

According to FIG. 6, a normal force F_{Q} on the one hand and a transverse force F_{Y} is generated by a rolling wheel 73, whereby F_{Y} runs at a right angle to F_{Q} as well as at a right angle to the longitudinal axis of the rail 70. In order to detect both transverse forces F_{Q} and F_{Y}, there is a need for two transmitter-receiver units 32, 32′, each having a receiver 3, 3′, that are positioned on opposite sides relative to the rail 70. Accordingly, F_{Q} and F_{Y} are calculated according to the following formulas:

$$\begin{matrix}{F}_{Q} = \frac{Δ {α}_{1} + Δ {α}_{2}}{2} \\ {F}_{Y} = \frac{Δ {α}_{1} - Δ {α}_{2}}{Δ {α}_{1} + Δ {α}_{2}}\end{matrix}$$

FIG. 7 shows the measuring signal of a double load cycle. Before the sensing point is reached, the wheel load relieves the rail 70 in the area of the sensing point, since the adjacent rail section is being loaded. The measuring signal has a signal drop L1. Once the sensing point is reached, the measuring signal jumps to a first maximum M1 analogously to the load at the sensing point and, after the first wheel has passed, this measuring signal drops again. Subsequently, the measuring signal rises again to a second maximum value M2 when the second wheel passes. After the passage of the second wheel, the signal drops once again analogously to the situation when the wheel is approaching.

FIG. 8 shows the rail bed depicted schematically from above, with a railroad tie 75 and a pair of rails 70, 70′. Relative to the direction of travel of the train, to the left of the transmitter-receiver unit 32 or 32′, there is a digital or analog detection switch 80 followed by six transmitter-receiver units 32 on each side of the rail. The transmitter-receiver units 32 here are arranged alternately on the inside and on the outside of the rail 70. As an alternative, these can be arranged either only on the inside or only on the outside. Subsequently, there is another detection switch 81′. By means of the detection switch 81, 81′, the speed of the train, the number and the relative position of the wheels can be determined and the measuring segment can be activated or deactivated.

The measuring graph G shown in FIG. 9a1, which was determined between two railroad ties 75, 75′ or between the middle of the two railroad ties 75, 75′, is divided according to FIG. 9a2 into five specific measuring points. The specific measuring points P3 to P7 serve for the further signal processing or correlation with a correction graph according to FIG. 9b2.

FIG. 9b1 shows a measuring graph G with a first relative maximum R1 and a second relative maximum R2. These relative maxima are generated due to a flat section of the wheel and the associated alternating load of the rail. The flat section leads to a brief drop in the load and thus to a relative minimum F of the graph G.

In order to obtain an independent comparison graph or correction graph K, a correction graph K is determined from all graphs showing a good wheel and this graph K is shown in FIG. 9b2. The correction graph K is like an average load cycle of a perfect wheel per sensor and per train passage and thus has neither relative maxima nor relative minima.

FIG. 9c1 shows the series of all correction graphs K1 to K6 of six consecutive sensing points. The sensing points here cover a rail section of about 3.60 meters. This length corresponds to at least one wheel circumference. The measuring segments overlap each other here by 100 mm towards each side, thus ensuring a seamless detection of the load over the entire rail section. FIG. 9c2 shows the normal load graphs N1 to N6 for each sensing point 1 to 6 generated by the wheel load cycles. For each normal load graph N, approximately ⅙ of the wheel circumference is shown here. Accordingly, the first half of the measured wheel has a flat section F that, according to FIG. 9b1, follows a plotted curve A.

FIG. 9d shows the ratio of the normal load graph N to the correction graph K for a wheel circumference as a load plateau, said ratio ensuring a percentage representation of the rail load with reference to the basic load. Here, the normal load graph N according to FIG. 9e is the normalized mean value of all measuring graphs G of a train passage. Irregularities of each wheel or of the measuring graph G are retained here. The normal load graph N and the reciprocal value of the correction graph K are superimposed here as shown in FIG. 9e and they have a shared mirror value S, by means of which the ratio shown in FIG. 9d is determined according to the following formula:

$$Q = \frac{S - N}{\frac{1}{K} - S}$$

According to FIG. 9f, specific wheel flaws per wheel rotation can be recognized on the basis of the generated measuring graphs. According to FIG. 9e1, this is a plotting on the wheel that first generates an overload. The graph according to FIG. 9e2 shows relatively high-frequency, symmetrical load changes that point towards polygons. FIG. 9e3 shows a typical signal of an out-of-roundness of the wheel that leads to a symmetrical graph of a low-frequency type. FIG. 9e4 shows a typical flat section of the wheel that first generates a load drop and subsequently an overload.

List of Reference Numerals

1 component
2 transmitter
3 receiver
3′ receiver
3.1 receiver
4 measuring beam
11 opposite side
12 opposite side
20 first receptacle
20.1 first leg
20.2 second leg
21 first holding part
21.1 thread
22 screwed joint
23 clamping element
23.1 thread
24 holding element
30 second receptacle
31 second holding part
32 transmitter-receiver unit
32′ transmitter-receiver unit
40 fit
41 groove
41′ groove
42 tongue
50 adjustment surface
50′ adjustment surface
51 assembly device
52 adjustment element
52′ adjustment element
60 evaluation unit
70 rail
70′ rail
71 rail head
72 rail head
72′ rail foot
73 rail foot
75 railroad tie, support
75′ railroad tie, support
80 detection switch
80′ detection switch
81 detection switch
81′ detection switch

1-16. (cancelled)

17. A device for holding a transmitter and a receiver for detecting a deformation state of a component, the device comprising:
a first holding part;
a first receptacle, the transmitter being disposed on the first holding part via the first receptacle, wherein the first receptacle and the first holding part, together with the component, form at least one of a first connecting element, a first clamp, a first positive fit joint, a first glued joint, and a first welded joint;
a second holding part; and
a second receptacle, the receiver is being disposed on the second holding part via the second receptacle, wherein the second receptacle and the second holding part, together with the component, form at least one of a second connecting element, a second clamp, a second positive fit joint, a second glued joint, and a second welded joint.

18. A device for detecting a deformation state of a railroad rail, the device comprising:
a deformation sensor disposed on the railroad rail, wherein the deformation sensor is arranged directly on a foot of the rail in a longitudinal direction of the railroad rail.

19. The device as recited in claim 17, wherein the first receptacle is connected to the first holding part via a first fit and the second receptacle is connected to the second holding part via a second fit.

20. The device as recited in claim 17, wherein each of the fist and second fits are configured as at least one a groove-and-tongue joint and a location pin.

21. The device as recited in claim 17, further comprising at least one of a pin joint and a bolted joint, and wherein each of the first and second receptacles includes a lug and is connected to the respective holding part using the at least one of the pin joint and the bolted joint.

22. The device as recited in claim 17, wherein at least one of the first receptacle and the first holding part includes a clamping element in operative connection with the component.

23. The device as recited in claim 22, wherein the clamping element includes at least one of a bolt, a screw and a cam.

24. The device as recited in claim 22, wherein at least one of the first and second receptacles includes a holding element configured to hold one of the transmitter and the receiver.

25. The device as recited in claim 23, wherein the holding element includes a bore and a fastening element including a cap screw.

26. The device as recited in claim 17, further comprising an assembly device and wherein the first receptacle and the second receptacle each have at least one corresponding adjustment surface joined to one another using the assembly device.

27. The device as recited in claim 26, wherein the adjustment surface is configured as one of a groove, a bore and a bevel, and wherein the assembly device includes adjustment elements, each corresponding to one of the adjustment surfaces.

28. The device as recited in claim 26, further comprising an evaluation unit, wherein the component includes a measuring area and wherein the second receptacle is disposed in the measuring area and is in operative connection with the evaluation unit.

29. The device as recited in claim 28, further comprising a further transmitter in operative connection with a further receiver, the further transmitter and further receiver being disposed on an opposite side of the component from the receiver and the transmitter.

30. A method for measuring the deformation of a component using the device of claim 29, the method comprising:
generating a measuring current by the receiver;
transforming the measuring current into a measuring voltage inside the evaluation unit;
determining an angular change between the transmitter and the receiver according to the following formula:
$$\frac{{U}_{1} - {U}_{2}}{{U}_{1} + {U}_{2}} = Δ {α}_{1}$$
determining a load force F_{Q} in a vertical direction and a load force F_{Y} in a direction perpendicular to the vertical direction, the deformation state of the component in the being based on the load forces F_{Q} and F_{Y}, the determining of the load forces being performed based on the following formulae:
$$\begin{matrix}{F}_{Q} = \frac{Δ {α}_{1} + Δ {α}_{2}}{2} \\ {F}_{Y} = \frac{Δ {α}_{1} - Δ {α}_{2}}{Δ {α}_{1} + Δ {α}_{2}}\end{matrix}$$
wherein α₁ is the angular change between the transmitter and the receiver and α₂ is the angular change between the further transmitter and the further receiver.

31. The method as recited in claim 30, further comprising:
detecting a deformation ΔX of the component as a function of a length L of the component, the deformation ΔX being proportional to the detected angular change Δα;
determining a mean value formation ΔX′ from a plurality of deformation graphs of a load cycle;
normalizing a deformation graph “X over L” using the mean value formation ΔX′; and
calculating a ratio of the deformation ΔX to the normalized deformation ΔX′.

32. The device as recited in claim 16, wherein the component is a rail, the first and second holding parts are disposed underneath a foot of the rail, and the first and second receiving receptacles are disposed holding part in a height-adjustable manner, wherein each of the first and second connecting elements is formed by a respective one of the first and second holding parts and by a respective one of the first and second receiving receptacles, and wherein the receiving receptacle includes a first leg, a second leg, and a first screw and a second screw passing through the first leg, the first screw being disposed against the rail foot and the second screw providing a fixed connection between the holding part and the rail and pressing the second leg against the holding part.
